(19) United States
(12) Patent Application Publication
(10) Pub. No.: US 2015/0380945 A1
(43) Pub. Date: Dec. 31, 2015

(54) INDUCTIVE ENERGY TRANSFER APPARATUS AND METHOD FOR POSITION DETECTION AND/OR PRESENCE DETECTION BY WAY OF AN INDUCTIVE ENERGY TRANSFER APPARATUS

(71) Applicant: Robert Bosch GmbH, Stuttgart (DE)

(72) Inventors: Dragan KRUPEZEVIC, Stuttgart (DE); Juergen MACK, Goeppingen (DE)

(21) Appl. No.: 14/746,209

(22) Filed: Jun. 22, 2015

(30) Foreign Application Priority Data
Jun. 26, 2014 (DE) 10 2014 212 258.9

(51) Int. Cl. H02J 5/00; H02J 7/00; G01D 5/20; H02J 7/02

(52) U.S. Cl. CPC H02J 5/005; H02J 7/025; H02J 7/0044; G01D 5/2006

(57) ABSTRACT

An inductive energy transfer apparatus, in particular a handheld power tool inductive energy transfer apparatus, is provided as having at least one coil unit that in at least one state is provided for energy transfer to at least one external coil unit, and having at least one open-and/or closed-loop control unit that is provided at least in order to evaluate at least one coil quality parameter for position detection and/or presence detection. It is proposed that the open- and/or closed-loop control unit be provided additionally at least in order to evaluate at least one coil coupling parameter for position detection and/or presence detection.

### BACKGROUND INFORMATION

German Published Patent Application No. 10 2011 086 904 A1 has already disclosed an apparatus and a method for inductive energy transfer, having a coil unit that is provided for energy transfer to an external coil unit, an open- and/or closed-loop control unit being provided in order to evaluate a coil quality

### SUMMARY

The invention proceeds from an inductive energy transfer apparatus, in particular from a handheld power tool inductive energy transfer apparatus, having at least one coil unit that in at least one state is provided for energy transfer to at least one external coil unit, and having at least one open- and/or closed-loop control unit that is provided at least in order to evaluate at least one coil quality parameter for position detection and/or presence detection in particular of the at least one external coil unit and/or of at least one foreign object.

It is proposed that the open- and/or closed-loop control unit be provided additionally at least in order to evaluate at least one coil coupling parameter for position detection and/or presence detection in particular of the at least one external coil unit and/or of at least one foreign object.

An “inductive energy transfer apparatus” is to be understood in this connection in particular as an apparatus that in at least one state is provided, in particular by way of the at least coil unit, to supply at least one further apparatus which in particular has the at least one external coil unit, in particular an electrical apparatus, preferably a workpiece-processing power tool apparatus and particularly preferably a handheld power tool apparatus, and/or any other electrical object that seems useful to one skilled in the art, for example an autonomous locomotion device, with energy, in particular electrical energy, in contactless fashion, in particular inductively and/or via a magnetic field. The energy transfer can be accomplished in particular over distances of a few millimeters, in particular 0.1 mm and preferably 1 mm, up to several centimeters, in particular 1 cm and preferably 10 cm. A “coil unit” is to be understood here in particular as a unit and/or a part of a resonance-capable electrical circuit, preferably an electrical oscillator circuit, that in at least one state is provided in order to convert electrical energy into a magnetic field, in particular an alternating magnetic field, and/or to convert a magnetic field, in particular an alternating magnetic field, into electrical energy. The coil unit encompasses for this purpose in particular at least one coil and preferably at least one capacitor. A “handheld power tool apparatus” is furthermore to be understood in particular as at least a part and/or a subassembly of a handheld power tool. In this connection, a “handheld power tool” is to be understood in particular as any workpiece-processing handheld power tool that seems useful to one skilled in the art, but advantageously as a rechargeable screwdriver, a rechargeable drill, a power drill, a drill driver and/or impact driver, a saw, a plane, a screwdriver, a milling cutter, a grinder, an angle grinder, a garden tool, and/or a multifunction tool. “Provided” is to be understood in particularly as specially programmed, designed, and/or equipped. The inductive energy transfer apparatus could be embodied, for example, as a drive apparatus and/or part of a drive apparatus, in particular of an electric motor. Advantageously, however, the inductive energy transfer apparatus is embodied as a part, in particular as a subassembly, of a charging apparatus. In particular, the inductive energy transfer apparatus can also encompass the entire charging apparatus. Preferably the inductive energy transfer apparatus is embodied as a charging device, a charging cradle, and/or a charging plate, and/or as part of a charging device, a charging cradle, and/or a charging plate. In this case the at least one further apparatus that in particular has the at least one external coil unit is embodied in particular as an energy reservoir apparatus and/or as part of an energy reservoir apparatus. A “charging apparatus” is to be understood in this connection in particular as an apparatus for charging at least one energy reservoir apparatus, in particular a rechargeable battery apparatus, in particular a rechargeable battery, in particular by way of an inductive energy transfer in particular from the at least one coil unit to the at least one external coil unit. An “energy reservoir apparatus” is to be understood here in particular as an apparatus for, in particular temporary, storage of electrical energy. Preferably the energy reservoir apparatus encompasses a reservoir, in particular for electrical energy, that is rechargeable in particular at least 100 times, preferably at least 500 times, and particularly preferably at least 1000 times, and that in particular is electrically connected to the at least one external coil unit. The energy reservoir apparatus can be embodied as any energy reservoir apparatus that seems useful to one skilled in the art, but preferably as a rechargeable battery, in particular as a rechargeable nickel cadmium battery and/or as a rechargeable lithium ion battery.

Particularly preferably, the charging apparatus is embodied as a handheld power tool energy reservoir charging apparatus, and the energy reservoir unit as a handheld power tool energy reservoir apparatus. A “handheld power tool energy reservoir apparatus” is to be understood here in particular as an energy reservoir apparatus, preferably embodied as a rechargeable battery, for a handheld power tool. Furthermore, a “handheld power tool energy reservoir charging apparatus” is to be understood in particular as a charging apparatus that is provided for charging a handheld power tool energy reservoir apparatus. An “open- and/or closed-loop control unit” is to be understood in particular as an electrical and/or electronic unit having at least one electronic control system. An “electronic control system” is to be understood in particular as a unit having a calculation unit and having a memory unit, and having an operating program, open-loop control program, and/or closed-loop control program stored in the memory unit, which program is provided in particular in order to be executed by the calculation unit. A “foreign object” is furthermore to be understood as an, in particular unattached, object that in particular is free of any connection to the inductive energy transfer apparatus, to the charging apparatus, and/or to the energy reservoir apparatus and in particular is not present and/or required in a normal operating state and/or normal charging state. A “foreign object” is to be understood in particular as an object that in at least one state is disposed, in particular at least in a viewing direction perpendicular to a principal extension plane of the at least one coil unit and/or of the at least one external unit, at least in part between the at least one coil unit and the at least one external coil unit. In particular, the foreign object can become warm and/or hot under the influence of a magnetic field, in particular an alternating magnetic field. A “normal operating state and/or a normal charging state” is to be understood in this connection in particular as a state, in particular provided by a manufacturer and/or operator, in which, in particular, operationally reliable use of the inductive energy transfer apparatus exists. A “principal extension plane” of an object is furthermore to be understood in particular as a plane that is parallel to a largest lateral surface of a smallest imaginary cuboid that just completely encloses the object, and in particular extends through a center point, in particular a geometric center point, of the cuboid. A “coil quality parameter” is furthermore to be understood in particular as at least one parameter that in particular is correlated with at least one coil quality at least of the at least one coil unit and/or of the at least one external coil unit. The open- and/or closed-loop control unit can in particular, at least on the basis of the coil quality parameter, infer, preferably unequivocally, the coil quality and/or ascertain and/or determine a coil quality. Preferably the at least one coil quality parameter is identical to the coil quality. A “coil quality” is to be understood in this connection in particular as a factor that describes a damping of an oscillation-capable and/or resonance-capable electrical circuit and/or a ratio between an electrical energy stored in the oscillation-capable and/or resonance-capable electrical circuit and an energy loss. A “coil coupling parameter” is furthermore to be understood in particular as at least one parameter that is correlated in particular with at least one coil coupling at least of the at least one coil unit and/or of the at least one external coil unit. The open- and/or closed-loop control unit can in particular, at least on the basis of the coil coupling parameter, infer, preferably unequivocally, the coil coupling and/or ascertain and/or determine a coil coupling. Preferably the at least one coil coupling parameter is identical to the coil coupling. A “coil coupling” is to be understood in particular as a factor that describes an, in particular geometric, orientation and/or disposition of at least one coil, in particular of the at least one coil unit, with respect to at least one further coil, in particular the at least one external coil unit.

The configuration of the inductive energy transfer apparatus in particular allows a maximally efficient energy transfer to be achieved, with the result that in particular costs can be reduced and losses minimized. In addition, in particular, possible foreign objects can be detected, in particular reliably, in particular between the at least one coil unit and the at least one external coil unit, with the advantageous result that an operating dependability can be enhanced.

Preferably the open- and/or closed-loop control unit is provided in order to act upon at least the external coil unit in at least one state with a load parameter in order to evaluate the at least one coil coupling parameter. A “load parameter” is to be understood in this connection in particular as a resistance parameter and/or a resistance factor, in particular one, preferably constant, impedance, and/or at least one, preferably constant, resistance. The open- and/or closed-loop control unit is provided in particular to connect the external coil unit in the at least one state to the at least one impedance and/or to the at least one resistance, and/or to short-circuit it via the at least one impedance and/or the at least one resistance, thereby making possible in particular a current flow, in particular through the external coil unit. The result is that, in particular, a coil coupling parameter can be identified in advantageously simple fashion.

If the open- and/or closed-loop control unit is provided in order to sense the at least one coil quality parameter and/or at least one coil quality parameter pair, preferably made up of the at least one coil quality and at least one resonant frequency, while the external coil unit is in an unloaded and/or open state, at least one coil quality parameter can be ascertained in advantageously simple fashion. An “unloaded and/or open state” is to be understood in this connection in particular as a state in which the external coil unit is free of any action upon it by a load parameter, and/or the external coil unit is free of a current flow.

It is further proposed that the open- and/or closed-loop control unit be provided in order to sense at least one further coil quality parameter and/or at least one further coil quality parameter pair, preferably made up of the at least one further coil quality and at least one resonant frequency, while the external coil unit is in a loaded and/or closed state. A “loaded and/or closed state” is to be understood in this connection in particular as a state in which the external coil unit is acted upon by a load parameter. The result thereof is, in particular, that at least one further coil quality parameter can be identified in advantageously simple fashion and can be utilized in particular to ascertain a coil coupling parameter.

It is furthermore proposed that the open- and/or closed-loop control unit utilize, for evaluation of the at least one coil coupling parameter, a difference between the coil quality parameter and/or the coil quality parameter pair and the further coil quality parameter and/or the further coil quality parameter pair. The result thereof is that in particular a coupling between the at least one coil unit and the at least one external coil unit can be ascertained in advantageously simple fashion, so that, in particular, inefficient operation can be prevented and possible foreign objects can advantageously be detected.

Preferably the inductive energy transfer unit has at least one coil movement unit that is provided in order to move at least the coil unit at least as a function of the at least one coil quality parameter evaluated by way of the open- and/or closed-loop control unit, and as a function of the coil coupling parameter evaluated by way of the open- and/or closed-loop control unit. A “coil movement unit” is to be understood in this connection in particular as a unit having at least one actuator element that is provided in particular in order to move the coil unit as a result of a control application in particular by the open- and/or closed-loop control unit, in particular in at least one spatial direction, preferably in at least two spatial directions and particularly preferably in three spatial directions, in particular by at least 0.5 cm, preferably at least 1 cm, and particularly preferably at least 5 cm. Preferably the at least one actuator element is mechanically coupled to the coil unit. An “actuator element” is to be understood in this connection in particular as a mechatronic component that is provided in particular in order to convert electrical signals into a movement, in particular a pivoting and/or preferably linear movement. In particular, a movement speed is at least 0.1 m/s, preferably at least 0.5 m/s, and particularly preferably at least 1 m/s. Alternatively and/or additionally, it is also conceivable for the at least one further apparatus that has in particular the at least one external coil unit, in particular the energy reservoir apparatus, to have at least one further coil movement unit that is provided in order to move at least the external coil unit at least as a function of the at least one coil quality parameter evaluated by way of the open- and/or closed-loop control unit and as a function of the coil coupling parameter evaluated by way of the open- and/or closed-loop control unit. In particular, the at least one further apparatus can have a further open- and/or closed-loop control unit that is connected to and/or communicates with the open- and/or closed-loop control unit in particular via at least one wireless connection, in particular an infrared connection, a Bluetooth connection, a WLAN connection, radio connection, and/or NFC connection. The result is that in particular a poor coil coupling between the coil unit and the external coil unit can advantageously be compensated for, with the result that in particular an energy transfer efficiency can be maximized.

It is further proposed that the inductive energy transfer apparatus have at least one output unit that is provided in order to output and/or indicate to an operator at least one position parameter and/or one presence parameter, in particular of the at least one external coil unit and/or of at least one foreign object. A “position parameter” is to be understood in this context in particular as a parameter that is correlated with an, in particular geometric, position of an object, in particular of the at least one external coil unit and/or of at least one foreign object. In particular the open- and/or closed-loop control unit can, at least on the basis of the position parameter, infer, preferably unequivocally, the position of the object and/or ascertain and/or determine the position of the object. A “presence parameter” is to be understood in this context in particular as a parameter that is correlated with a presence and/or absence of an object, in particular of the at least one external coil unit and/or of at least one foreign object. In particular the open- and/or closed-loop control unit can, at least on the basis of the presence parameter, infer, preferably unequivocally, the presence and/or absence of the object and/or ascertain and/or determine the presence and/or absence of the object. An output can be accomplished in particular acoustically, haptically, and/or preferably visually, for example via at least one indicating unit, for example a seven-segment indicator, a TFT display screen, at least one backlit symbol, and/or at least one LED. A user can thereby advantageously be informed as to possible foreign objects.

In a preferred embodiment of the invention it is proposed that the open- and/or closed-loop control unit be provided in order to output to an operator by way of the output unit, at least as a function of the at least one coil quality parameter evaluated by way of the open- and/or closed-loop control unit and as a function of the coil coupling parameter evaluated by way of the open- and/or closed-loop control unit, a positioning stipulation of the coil unit and of the external coil unit relative to one another. A “positioning stipulation” is to be understood here in particular as an, in particular acoustic, haptic, and/or visual, stipulation, in particular to a user, which is provided in particular in order to signal to a user a, preferably optimal and/or most efficient, disposition and/or orientation of an object to be positioned. The result thereof is that an energy transfer efficiency can be maximized, advantageously simply and in particular economically, directly by a user.

Also proposed is a method for position detection and/or presence detection by way of an inductive energy transfer apparatus having at least one coil unit that in at least one state is provided for energy transfer to at least one external coil unit, at least one coil quality parameter and additionally at least one coil coupling parameter being evaluated for position detection and/or presence detection. The result is that in particular a maximally efficient energy transfer is achieved, and an operational dependability can advantageously be enhanced.

Also proposed is an inductive charging system having at least one energy reservoir apparatus, in particular a handheld power tool energy reservoir apparatus, and having at least one charging apparatus having at least one inductive energy transfer apparatus. The result is that in particular a user-friendly and operationally dependable inductive charging system can be implemented, such that energy transfer efficiency advantageously can be maximized and thus in particular a charging time can be reduced.

The inductive energy transfer apparatus and/or the method for position detection and/or presence detection by way of an inductive energy transfer apparatus is/are not to be limited here to the above-described utilization and embodiment. In particular, the inductive energy transfer apparatus and/or the method for position detection and/or presence detection by way of the inductive energy transfer apparatus can have, in order to perform a function described herein, a number of individual elements, components, and units, as well as method steps, that deviates from a number recited herein. In addition, in the context of the value ranges indicated in this disclosure, values lying within the recited limits are also considered to be disclosed and discretionary.

### BRIEF DESCRIPTION OF THE DRAWINGS

FIG. 1 schematically depicts a handheld power tool, embodied as a rechargeable screwdriver, having an energy reservoir apparatus;

FIG. 2 is a schematic partial depiction of an inductive charging system for inductive energy transfer, having at least one inductive energy transfer apparatus that has a coil unit, and having the energy reservoir apparatus that has an external coil unit;

FIG. 3 shows an example of a first disposition of the coil unit and of the external coil unit;

FIG. 4 shows an example of a second disposition of the coil unit and of the external coil unit; and

FIG. 5 shows a resonant frequency and coil quality ascertained from the first disposition and from the second disposition.

### DETAILED DESCRIPTION

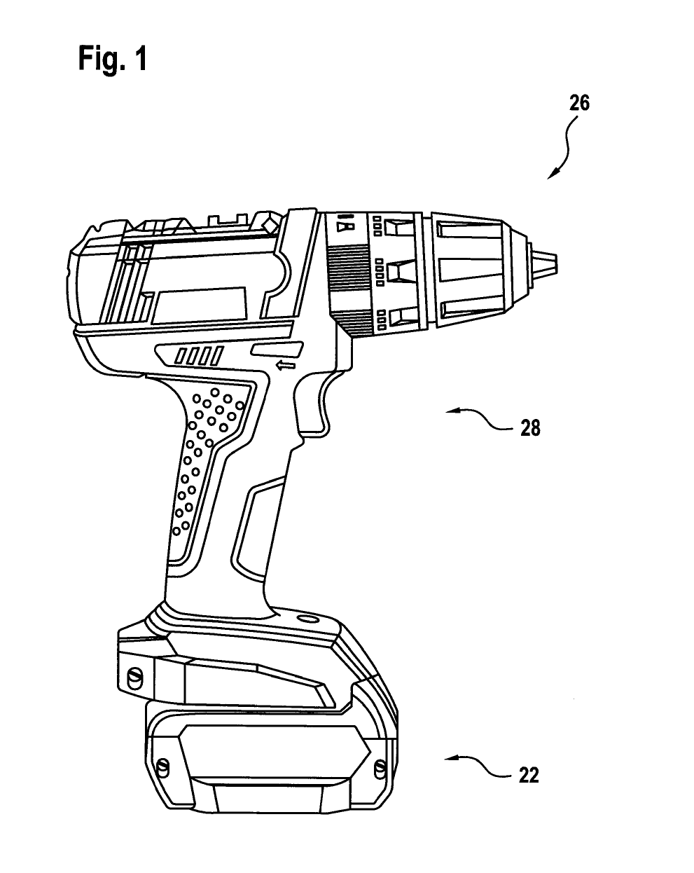

FIG. 1 schematically depicts a cordless handheld power tool 26 embodied as a rechargeable screwdriver. Handheld power tool 26 has a processing apparatus 28. In the present case processing apparatus 28 is provided in order to enable drilling processing and/or screwdriving processing. Handheld power tool 26 furthermore has an energy reservoir apparatus 22. Energy reservoir apparatus 22 is embodied as a handheld power tool energy reservoir apparatus. Energy reservoir apparatus 22 can be connected via a latching connection to processing apparatus 28. Energy reservoir apparatus 22 is disposed in a lower region of handheld power tool 26, in particular on a side facing away from processing apparatus 28. Energy reservoir apparatus 22 is embodied as a rechargeable battery. In the present case energy reservoir apparatus 22 is embodied as a rechargeable lithium ion battery. Energy reservoir apparatus 22 is provided in order to store electrical energy and to make it available in particular to a drive unit of handheld power tool 26. Energy reservoir apparatus 22 has for that purpose a rechargeable reservoir. In the present case the reservoir can be recharged at least 2000 times. Alternatively, a handheld power tool can also be embodied as any other handheld power tool that seems useful to one skilled in the art.

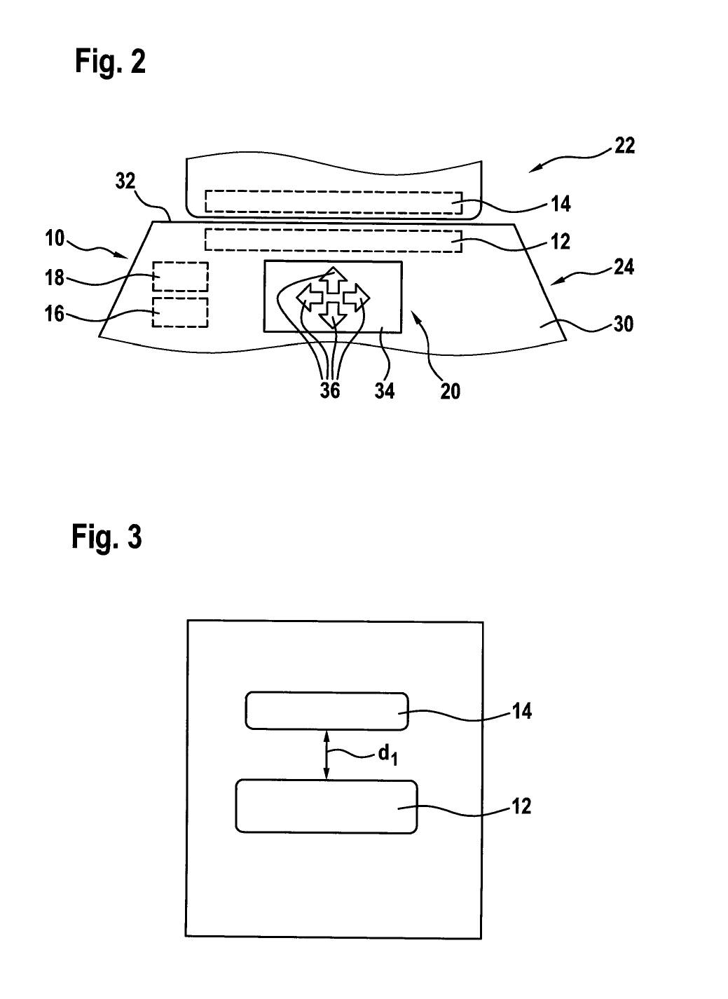

In the present case energy reservoir apparatus 22 is embodied as part of an inductive charging system for inductive energy transfer (see FIG. 2). Energy reservoir apparatus 22 is embodied as an energy receiver. Energy reservoir apparatus 22 has an external coil unit 14. In the present case external coil unit 14 has at least one external coil. The at least one external coil is embodied in at least substantially plate-like fashion. The at least one external coil has an area of approximately 2×2 cm². External coil unit 14 is disposed in a lower region of energy reservoir apparatus 22, in particular on a side facing away from processing apparatus 28. External coil unit 14 is electrically conductively connected to the reservoir of energy reservoir apparatus 22.

The inductive charging system furthermore encompasses a charging apparatus 24. Charging apparatus 24 is embodied in the present case as a handheld power tool energy reservoir charging apparatus. Charging apparatus 24 is embodied as a charging plate. Charging apparatus 24 encompasses a housing unit 30. Housing unit 30 has an at least substantially flat upper side 32. Charging apparatus 24 furthermore encompasses an inductive energy transfer apparatus 10.

Inductive energy transfer apparatus 10 is embodied as an energy transmitter. Inductive energy transfer apparatus 10 has a coil unit 12. Coil unit 12 has a coil. The coil is embodied in at least substantially plate-like fashion. The coil has an area of approximately 3×3 cm². Coil unit 12 furthermore has a capacitor. Coil unit 12 is embodied as an electrical oscillator circuit. In the present case, coil unit 12 is electrically conductively connected to a power unit (not depicted). The power unit encompasses at least two switches. One of the at least two switches is electrically conductively connected to an energy source. The other of the at least two switches is electrically conductively connected to a ground contact. Coil unit 12 is furthermore disposed in an upper region of inductive energy transfer apparatus 10, in particular on a side facing toward energy reservoir apparatus 22 and/or toward upper side 32. Alternatively, a coil unit and/or an external coil unit could also have any other number of coils, for example two, three, and/or four coils, and/or further elements, for example capacitors, switches, and/or resistors.

Inductive energy transfer apparatus 10 further encompasses an open- and/or closed-loop control unit 16 having an electronic control system (not depicted) for operating inductive energy transfer apparatus 10. The electronic control system encompasses a calculation unit, a memory unit, and an operating program stored on the memory unit.

In the present case coil unit 12 in at least one state, in particular in a charging state, is provided for inductive and noncontact energy transfer to external coil unit 14. When external coil unit 14 is in the immediate vicinity of coil unit 12, open- and/or closed-loop control unit 16 is provided in order to excite a periodic alternating current in coil unit 12. In the present case, open- and/or closed-loop control unit 16 is provided in order to excite the periodic alternating current in coil unit 12 by alternatingly and periodically opening and closing the at least two switches of the power unit. A switching frequency of the at least two switches is between 25 kHz and 150 kHz. The alternating current flowing through coil unit 12 generates an alternating magnetic field that has in particular a frequency between 25 kHz and 150 kHz. Coil unit 12 is accordingly provided in order to convert electrical energy into a magnetic field. The alternating magnetic field induces an alternating current in external coil unit 14. External coil unit 14 is accordingly provided in order to convert a magnetic field into electrical energy. External coil unit 14 is furthermore provided in order to deliver the converted electrical energy to the reservoir, in particular in order to charge the latter.

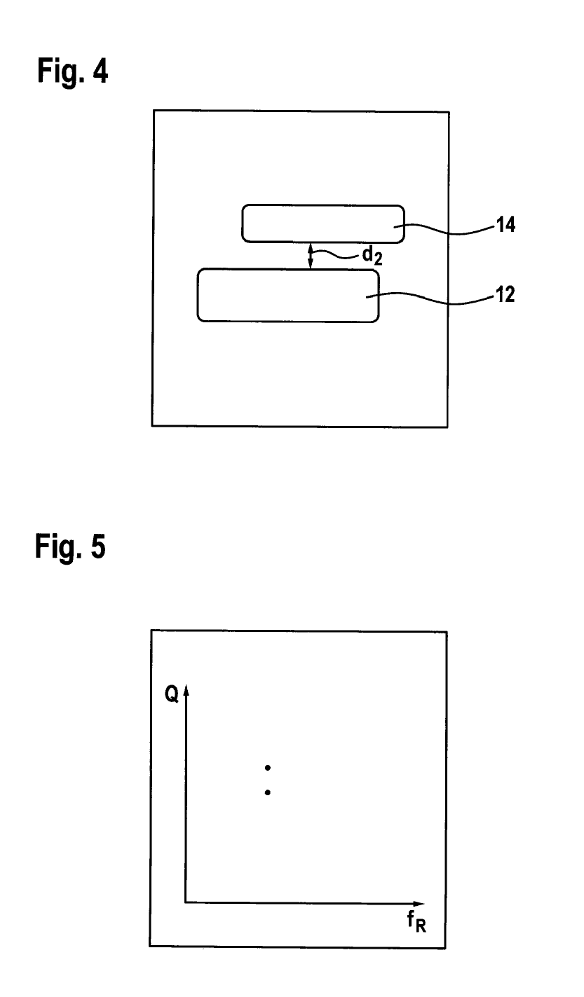

Open- and/or closed-loop control unit 16 is furthermore provided, in particular before and during inductive energy transfer, to evaluate at least one coil quality parameter for position detection and/or presence detection of external coil unit 14. Open- and/or closed-loop control unit 16 is provided in order to identify a coil quality Q at a resonant frequency f_{R}. In the present case the coil quality parameter is identical to a coil quality Q. The resonant frequency f_{R} and/or the coil quality Q depend on the mutual spacing of coil unit 12 and external coil unit 14. In addition, the resonant frequency f_{R} and/or the coil quality Q depend on an offset of coil unit 12 and external coil unit 14 with respect to one another. FIGS. 3 to 5 depict two different dispositions of coil unit 12 and of external coil unit 14, as well as a respective coil quality Q ascertained by way of open- and/or closed-loop control unit 16 at a resonant frequency f_{R}. FIG. 3 shows a disposition of coil unit 12 and external coil unit 14 with a spacing d₁ and with no lateral offset, whereas FIG. 4 shows a disposition of coil unit 12 and external coil unit 14 with a spacing d₂ that is smaller compared with the spacing d₁, and with a lateral offset. It is evident from FIG. 5 that in both cases the same resonant frequency f_{R} occurs but a respective coil quality Q is different. In the present case the arrangement of FIG. 3 has a lower coil quality Q than the arrangement of FIG. 4. This ambiguity makes it difficult to detect a possible foreign object between coil unit 12 and external coil unit 14, and/or complicates an optimum and/or maximally efficient disposition of external coil 14 relative to coil unit 12, when only the coil quality Q is evaluated.

It is proposed according to the present invention for this reason that open- and/or closed-loop control unit 16 be provided in order to additionally evaluate at least one coil coupling parameter for position detection and/or presence detection. In the present case the coil coupling parameter is identical to a coil coupling K. In a first step, open- and/or closed-loop control unit 16 is provided in order to sense a first coil quality parameter while external coil unit 14 is in an unloaded state. Open- and/or closed-loop control unit 16 is provided in order to detune a switching frequency of the at least two switches in a specific frequency range in order in particular to ascertain a resonant frequency f_{R} of coil unit 12 and/or of the electrical oscillator circuit. At the resonant frequency f_{R}, an amplitude of an alternating electrical current flowing in coil unit 12 and/or in the electrical oscillator circuit reaches a maximum. In the present case this amplitude directly represents an indication of the coil quality Q₁. Open- and/or closed-loop control unit 16 is furthermore provided in order to at least temporarily store in the memory unit a value pair made up of the ascertained resonant frequency f_{R} and the associated, in particular maximum, coil quality Q₁.

In a second step, open- and/or closed-loop control unit 16 is provided in order to sense a further coil quality parameter while external coil unit 14 is in a loaded state. In this state, open- and/or closed-loop control unit 16 is provided in order to act upon external coil unit 14 with a load parameter. In the present case open- and/or closed-loop control unit 16 is provided in order to electrically conductively connect external coil unit 14 to a resistance, which can be accomplished e.g. via a switching unit. Open- and/or closed-loop control unit 16 is then provided in order to ascertain a further coil quality Q₂ at a frequency that corresponds to the resonant frequency f_{R} of the coil quality Q₁. Open- and/or closed-loop control unit 16 is in turn provided in order to at least temporarily store in the memory unit a further value pair made up of the frequency, which in particular is identical to the resonant frequency f_{R} in the unloaded state, and the associated further coil quality Q₂. The further coil quality Q₂ is lower than the coil quality Q₁.

In a third step, open- and/or closed-loop control unit 16 utilizes a difference between the coil quality parameter, which in the present case is in particular identical to the coil quality Q₁, and the further coil quality parameter, which in the presence case is in particular identical to the further coil quality Q₂. The quality decline thereby obtained represents, in the present case, an indication of the coil coupling K, in particular because the coil quality Q₁ and the further coil quality Q₂ have the same frequency, in particular the resonant frequency f_{R} of the coil quality Q₁. The applicable relationship is:

K≈Q₁−Q₂ (1)

In the present case an evaluation of the at least one coil quality Q and/or of the coil coupling K takes place every 3 s. An evaluation start is initiated by a user. Alternatively, however, it is also conceivable for an evaluation to be initiated automatically, for example by a sensor unit that can encompass at least one weight sensor and/or at least one optical sensor. It is furthermore conceivable to carry out a continuous evaluation at any other time interval, for example every 10 s and/or every 60 s.

In the present case inductive energy transfer apparatus 10 furthermore additionally has a coil movement unit 18. Coil movement unit 18 has an actuator element (not depicted). The actuator element is embodied as an electromechanical actuator. The actuator element is provided in order to convert electrical signals into a linear movement. In the present case, coil movement unit 18 is provided in order to move coil unit 12 in the direction of upper side 32. Coil movement unit 18 is provided in order to move coil unit 12 at least 1 cm in the direction of upper side 32. Coil movement unit 18 is provided in order to move coil unit 12 as a function of the coil quality parameter and the coil coupling parameter ascertained and/or evaluated via open- and/or closed-loop control unit 16. In the present case, coil movement unit 18 is provided in order to adapt a position of coil unit 12 in such a way that a coil coupling K, a coil quality Q, and in particular an efficiency are optimized, with the result that inductive energy transfer occurs as efficiently as possible. Coil unit 12 and/or external coil unit 14 are disposed relative to one another in such a way that they can be brought closer to one another up to a minimum spacing of approximately 0.5 cm. Alternatively, it is also conceivable for a coil movement unit to encompass multiple actuator elements, for example three actuator elements, which can be disposed in particular in different spatial directions so that the coil unit can be moved in particular in three spatial directions. Alternatively and/or additionally, an energy reservoir apparatus could have a further coil movement unit that can be provided in particular in order to move the external coil unit so that, in particular, the coil unit and the external coil unit can be embodied movably.

Inductive energy transfer apparatus 10 furthermore has an output unit 20. Output unit 20 is provided in order to output a position parameter and/or a presence parameter to an operator. In the present case, output unit 20 is provided at least in order to output a position and/or a presence of external coil unit 14. Output unit 20 encompasses for this purpose an indicating unit 34. Indicating unit 34 is disposed on a lateral outer surface of housing unit 30. Indicating unit 34 encompasses four backlightable symbols 36. Symbols 36 are embodied in the present case as arrows. Any other number of symbols, for example two and/or three symbols, and/or any other symbols, are alternatively conceivable. Indicating unit 34 is provided in order to indicate a position and/or a presence of external coil unit 14 by backlighting of at least one of symbols 36. In order to increase an inductive energy transfer efficiency, open- and/or closed-loop control unit 16 is furthermore provided in order to output to an operator by way of indicating unit 34, at least as a function of the coil quality parameter and the coil coupling parameter evaluated by way of open- and/or closed-loop control unit 16, a positioning stipulation of coil unit 12 and of external coil unit 14. Open- and/or closed-loop control unit 16 is accordingly provided in order to backlight that symbol 36 which points in the direction in which an operator must move external coil unit 14 and/or energy reservoir apparatus 22 in order, in particular, to increase an inductive energy transfer efficiency, a coil coupling K, and/or an efficiency. Upon optimal orientation of external coil unit 14 relative to coil unit 12, open- and/or closed-loop control unit 16 is provided in order to at least temporarily backlight all symbols 36. Output unit 20 is moreover provided in order to output a presence of a foreign object. Output unit 20 encompasses an acoustic unit (not depicted) for this purpose. The acoustic unit is provided in order to signal to an operator, by way of a sound, that a foreign object is present between energy reservoir apparatus 22 and inductive energy transfer apparatus 10. Alternatively, an output unit can also have any other output means and/or a different number of output means, in particular haptic, visual, and/or acoustic output means.

What is claimed is:

1. An inductive energy transfer apparatus, comprising:
at least one coil unit that in at least one state is provided for energy transfer to at least one external coil unit; and
at least one of an open-loop control unit and a closed-loop control unit that evaluates at least one coil quality parameter for at least one of a position detection and a presence detection, wherein the at least one of the open-loop control unit and the closed-loop control unit evaluates at least one coil coupling parameter for at least one of the position detection and the presence detection.

2. The inductive energy transfer apparatus, as recited in claim 1, wherein the at least one of the open-loop control unit and the closed-loop control unit acts upon at least the external coil unit in at least one state with a load parameter in order to evaluate the at least one coil coupling parameter.

3. The inductive energy transfer apparatus, as recited in claim 2, wherein the at least one of the open-loop control unit and the closed-loop control unit senses the at least one coil quality parameter while the external coil unit is in an unloaded state.

4. The inductive energy transfer apparatus as recited in claim 3, wherein the at least one of the open-loop control unit and the closed-loop control unit senses at least one further coil quality parameter while the external coil unit is in a loaded state.

5. The inductive energy transfer apparatus as recited in claim 4, wherein the at least one of the open-loop control unit and the closed-loop control unit utilizes, for evaluation of the at least one coil coupling parameter, a difference between the coil quality parameter and the further coil quality parameter.

6. The inductive energy transfer apparatus as recited in claim 1, further comprising:
at least one coil movement unit that moves at least the coil unit at least as a function of the at least one coil quality parameter evaluated by way of the at least one of the open-loop control unit and the closed-loop control unit, and as a function of the coil coupling parameter evaluated by way of the at least one of the open-loop control unit and the closed-loop control unit.

7. The inductive energy transfer apparatus as recited in claim 1, further comprising at least one output unit that outputs to an operator at least one of at least one position parameter and a presence parameter.

8. The inductive energy transfer apparatus as recited in claim 7, wherein:
the at least one of the open-loop control unit and the closed-loop control unit is outputs to an operator by way of the output unit, at least as a function of the at least one coil quality parameter evaluated by way of the at least one of the open-loop control unit and the closed-loop control unit and as a function of the coil coupling parameter evaluated by way of the at least one of the open-loop control unit and the closed-loop control unit, a positioning stipulation of the coil unit and of the external coil unit relative to one another.

9. A method for at least one of a position detection and a presence detection by way of an inductive energy transfer apparatus that includes:
at least one coil unit that in at least one state is provided for energy transfer to at least one external coil unit; and
at least one of an open-loop control unit and a closed-loop control unit that evaluates at least one coil quality parameter for at least one of a position detection and a presence detection, wherein the at least one of the open-loop control unit and the closed-loop control unit evaluates at least one coil coupling parameter for at least one of the position detection and the presence detection.

10. An inductive charging system, comprising:
at least one energy reservoir apparatus; and
at least one charging apparatus that includes at least one inductive energy transfer apparatus that includes:
at least one coil unit that in at least one state is provided for energy transfer to at least one external coil unit, and
at least one of an open-loop control unit and a closed-loop control unit that evaluates at least one coil quality parameter for at least one of a position detection and a presence detection, wherein the at least one of the open-loop control unit and the closed-loop control unit evaluates at least one coil coupling parameter for at least one of the position detection and the presence detection.

11. The inductive energy transfer apparatus as recited in claim 1, wherein the inductive energy transfer apparatus is a handheld power tool inductive energy transfer apparatus.

12. The inductive charging system as recited in claim 10, wherein the energy reservoir apparatus is a handheld power tool energy reservoir apparatus.
